(19) United States
(12) Patent Application Publication
(10) Pub. No.: US 2009/0283282 A1
(43) Pub. Date: Nov. 19, 2009

(54) Electric hand-held power tool appliance

(75) Inventor: Heiko Zimmermann, Stuttgart (DE)

Correspondence Address: CENTRAL COAST PATENT AGENCY, INC, 3 HANGAR WAY SUITE D, WATSONVILLE, CA, 95076, US

(73) Assignee: METABOWERKE GMBH, Nuertingen (DE)

(21) Appl. No.: 12/466,816

(22) Filed: May 15, 2009

(30) Foreign Application Priority Data
May 17, 2008 (EP) 08 009 157.2

(51) Int. Cl. B25D 17/24; B25D 17/04

(52) U.S. Cl. 173/162.2

(57) ABSTRACT

The invention relates to an electric hand-held power tool appliance, comprising a first housing part (14), in particular for accommodating a transmission and/or a drive motor for a tool, and comprising a second housing part (16), for constituting a handle (18) for guiding the electric hand-held power tool appliance (10), the first (14) and the second (16) housing part being connectable to one another, but being able to be vibrationally decoupled from one another, at least partially, in that at least one spring and damping element is arranged between the housing parts (14, 16) at at least one joining point (20, 22), there being provided, as a spring and damping element, a helical compression spring (24) having at least one rubber or rubber-elastic damping element (28) succeeding in an axial direction as viewed from a tool side.

### CROSS-REFERENCE TO RELATED DOCUMENTS

The present application claims priority to EP patent application serial number 08 009 157.2, which was filed on May 17, 2008, which is incorporated herein in its entirety, at least by reference.

### DESCRIPTION

The invention relates to an electric hand-held power tool appliance, comprising a first housing part, in particular for accommodating a transmission and/or a drive motor for a tool, and comprising a second housing part, for constituting a handle for guiding the electric hand-held power tool appliance, the first and the second housing part being connectable to one another, but being able to be vibrationally decoupled from one another, at least partially, in that at least one spring and damping element is arranged between the housing parts at least one joining point.

In the case of electric hand-held power tools, in many cases provision is made whereby two housing parts are used, the one housing part serving to accommodate, for example, the transmission or the motor, or to accommodate both the transmission and the motor, and the second housing part constituting, in particular, a handle region or handle, by means of which the electric hand-held power tool appliance can be held and guided. In particular, both housing parts can be produced from plastic or, alternatively, a housing can be realized as a metal housing.

In the case of electric hand-held power tool appliances, there has recently been an increasing emphasis upon the provision of a vibration damping. In this case, the provision of vibration-damped auxiliary handles has already been disclosed in the prior art. Such a system is already known from, for example, DE 40 11 124 A1.

In the case of a multiplicity of electric hand-held power tool appliances, the motor housing constitutes a main handle at the same time. In order to damp the vibrations in this case, there is known, for example from U.S. Pat. No. 5,027,910, the practice of arranging a shock-absorbing, elastomer material between an inner and an outer housing. Disadvantageous in this case, particularly if the motor housing is to be constituted as a handle, is that the size of the motor housing is greatly restricted in respect of the circumference, in order that the electric hand-held power tool appliance can still be gripped satisfactorily.

There is furthermore known, from DE 23 35 867 A1, an electric hand-held power tool appliance having a housing composed of plastic, wherein, in particular, the noise separation is to be reduced in that an outer housing composed of plastic is connected to a support housing via sound-damping bridges. It is likewise disadvantageous in this case that the required structural space is enlarged appreciably and, moreover, the production resource requirement is relatively large, compared with an undamped electric hand-held power tool appliance.

Finally, DE 102 44 793 discloses a hand-held power tool housing unit, in particular for a hand-held grinder, comprising at least two housing elements, which are connected to one another by means of a vibration-damping element. In the case of electric hand-held power tool appliances wherein the motor housing constitutes the handle element at the same time, this does not offer any advantage. Moreover, DE 102 44 793 discloses a vibration-damping system, a pure vibration-damping system having the problem that the vibration persists for longer in the system as a result of the damping.

Moreover, there is known from DE 100 55 395 A1 a system wherein a gas cushion is provided between two housing parts. A corresponding realization is already comparatively complicated.

Finally, EP 5 019 474 A1 discloses an electric hand-held power tool appliance of the generic type, the motor being fixed to the transmission housing and being freely arranged in the motor housing, and the transmission housing, being vibrationally decoupled from the motor housing, being connected to the latter.

In particular, in this case a plurality of spring damping systems can be provided, the spring and damping element being constituted, in particular, by a spring element made of rubber or of a rubber-elastic material. Further, it is already known that the spring and damping element has a spring stiffness in the axial spring direction that differs from that in a floating direction.

Proceeding from this prior art, it is now the object of the invention to provide a further vibration-reduced electric hand-held power tool appliance, in particular a drill or screwdriver or hammer drill, or percussion drill, wherein transmission of vibration to a handle is reduced.

This object is achieved in this case by an electric hand-held power tool appliance, wherein the spring and damping element comprises a helical spring having at least one succeeding rubber or rubber-elastic damping element.

Through the provision of both a helical spring and a, as viewed from the tool, succeeding damping element or buffer that can be composed of rubber or of a rubber-elastic material, it can be ensured that damping both in the axial direction, i.e. the direction of the machine main axis, and in a transverse direction can be effected. In this case, the wanted vibrational decoupling can be achieved particularly easily through the special selection of these two elements of the damping system. Moreover, the vibration in the system can be stabilized rapidly through the combination of spring and damping elements. Moreover, the design of the spring and damping element provides, as an elastic bearing, for a pitching motion of the first housing part in relation to the second housing part.

In this case, particularly in the case of electric hand-held power tool appliances having a tool that moves or rotates in a plane, such as, for example, angle grinders, but also power drills, there are produced vibrations that are oriented not merely in one direction, but that incite vibration of the electric hand-held power tool appliance in more than one direction in space. The vibration can be reduced in all three axes by means of a spring/damping arrangement according to the invention.

In this case, preferably, provision can be made whereby the damping element can be composed either of rubber or of a cellular elastomer that exhibits a rubber-elastic behavior.

The helical spring is realized as a compression spring.

These elements can be set particularly well in respect of the spring or damping characteristic, and can be varied within wide ranges in respect of their stiffness, both through the geometric shape and through the properties of the material per se, the rubber hardness, in particular, being selectable to be appropriate for the damping element. In this way, it is possible for a rubber damping element to be easily adapted to various applications and vibration characteristics of various electric hand-held power tool appliances. It is also possible in this case for the damping element to be so designed that the required handle stiffness is maintained, particularly in a floating direction. In this case, in order to prevent a spongy feel during working with the electric hand-held power tool appliance, the damping element may not prove, in particular, to be too soft in a floating direction.

The particular advantage in this case is in the series connection of the two different elements, the rubber or rubber-elastic damping element succeeding the helical spring. In this case, the axial vibration can be compensated by the spring element, which, preferably, is mounted on a guide rod in order to prevent tilting, and the vibration in the directions perpendicular thereto can be compensated by the rubber or rubber-elastic element, which can be fixed particularly well in the handle housing, in particular if it is a two-shell housing.

It can be particularly advantageous in this case if the helical spring has a spring stiffness that differs from that of the at least one rubber or rubber-elastic damping element. In this case, the two elements of the spring and damping element constitute a coupled oscillator having differing frequencies, it being possible to predefine a range in which an optimum vibration isolation occurs. The width of this frequency range, i.e. of the isolation range, is to be so empirically designed that the individual application can be so optimized, in dependence on the respective excitation frequency and on the handle mass and on the damping factors, in consideration of the estimate of hand and arm vibrations, that differing spring rates can be selected for the second elements, namely, helical spring and rubber or rubber-elastic damping element, in order to achieve an optimum vibration isolation. The spring system in this case is interposed between the housing parts, and thereby decouples the latter.

Achieved through the series connection in the axial direction, i.e. the main direction, namely, the drilling axis, for example, is that the spring and damping element is applied in the axial direction, and exclusively the rubber or rubber-elastic damping element acts in the axes perpendicular thereto. Consequently, the handle is stiffer in these perpendicular axes than along the drilling axis, and no spongy feel is produced during working. This can be further enhanced and set in a defined manner through the selection of appropriate spring rates.

Provision can be made, particularly preferably, whereby two joining points are provided for the two housing halves, such that a handle, in particular a D-shaped handle, is constituted by the second housing part, which is realized in a stirrup shape and which is coupled, at both sides of the stirrup, to the electric hand-held power tool appliance, and there to the first housing part. In the case of such a handle design, provision can be made whereby either a spring and damping system, comprising a helical spring and a rubber-elastic or rubber damping element, is provided at both joining points, or alternatively, a spring and damping element, comprising a helical spring and a rubber-elastic or rubber damping element, can be provided only at one, in particular, in the application case, the upper joining point, and only one damping element, consisting of one or more rubber dampers or rubber-elastic damping elements, which may be composed, in particular, of a cellular elastomer, can be provided at the second joining point. The upper joining point in this case is preferably located in the region of a tool shaft.

Alternatively, a joint, in particular a pivot joint, which preferably can be coupled to a damping element, in particular of a rubber material or of a rubber-elastic material, can also be provided at the lower joining point of the D-shaped handle.

If the housing part or parts is/are realized as two-shell housing parts consisting of two housing shells that bear on one another, the contact surface extending, in particular, axially, the damping element or elements can be arranged between the housing shells, the shells having a seating that accommodates the damping element, the seating preferably being located in the parting plane of the shells.

Moreover, provision can also be made whereby the spring element or elements, consisting of the helical spring, can be set and biased independently of the damping element. The helical spring in this case can be guided on a guide bolt, which is surrounded by the spring. Absorption of vibration in a purely axial direction is thereby ensured. The guide bolt can preferably be longitudinally adjustable, and follow the longitudinal variation of the helical spring upon adjustment of the spring rate of the latter. In general, the spring bias can be settable.

The damping element can be an annular damping element. In this case, there can be provided in the central opening of the damping element a sleeve via which a bias can be applied to the helical spring. The required mounting space for the spring/damper element can be optimized through the configuration.

The damping element can be designed to be movable or displaceable in the axial direction of the helical spring. In particular, through the connection of the displaceable damping element to the helical spring, which is guided on a guide bolt, there can be provided an elastic bearing of the handle and a damping in all directions, wherein the axial vibration damping is provided by the helical spring and the damping in the directions perpendicular to the axial direction is provided by the damping element, which are connected in series. The damping element is guided in its motion by the guide bolt and, if provided, a slide sleeve, which is provided between the guide bolt and the damping element. The guide bolt in this case is fixed to be solid with the housing. The setting of the spring bias can be effected via the slide sleeve, which cooperates indirectly or directly with the spring.

The spring and damping element in this case can be fixed as follows at the two housing parts. At the housing part that constitutes the handle, the spring and damping element, realized as above, can be positively accommodated and guided in a seating. At the other housing part, it can be fastened via a connection, effecting push-on, screwed or material closure, in particular of the guide bolt.

The invention is applicable, in principle, in the case of all electric hand-held power tool appliances, but in particular in the case of power drills, hammer drills and percussion drills, but also in the case of chisels and screwdrivers.

Further advantages and features of the invention are disclosed by the other application documents. The invention is explained more fully in the following with reference to a drawing, wherein:

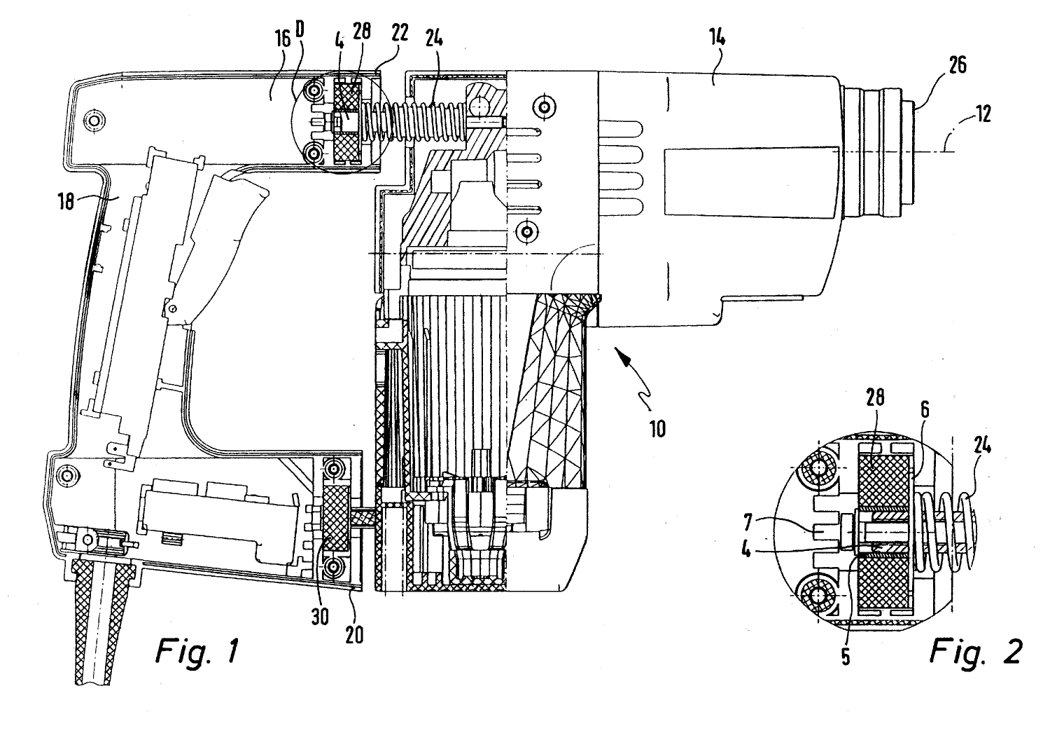

FIG. 1 shows a schematic representation of a hammer drill and

FIG. 2 shows a portion D from FIG. 1.

FIG. 1 shows, in its entirety, a hammer drill, which is denoted by the reference 10. The hammer drill in this case has a machine main axis 12, which denotes the axial direction of the appliance. The hammer drill 10 comprises a first housing part 14 and a second housing part 16, the two housing parts 14 and 16 together constituting the total housing of the hammer drill 10. In this case, the motor of the electric hand-held power tool, and a transmission, for transmitting the motor driving power to a drilling spindle (not represented), are provided in the first housing part 14. The second housing part 16 is realized as a handle in the form of a stirrup handle, the handle having the reference 18 and being fixed to the first housing part by means of two joining points 20 and 22.

In this case, the electric hand-held power tool appliance is held and guided, in essence, via the handle 18.

Provided at the two joining points 20 and 22 are elements that, on the one hand, serve to join the two housing parts 14 and 16 to one another and, at the same time, result in the vibrational decoupling of the two housing parts 14 and 16, which decoupling contributes to vibration-reduced working with the electric hand-held power tool appliance.

In this case, provision is made at the joining point 22 whereby an end of a guide bolt 4, which is fixed via its two ends in the housing part 16 on the one hand and in the housing part 14 on the other hand, and which is variable in respect of its length in the axial direction, is wrapped around by a helical spring 24, which is realized as a compression spring and which biases the two housing parts 14 and 16 against one another. In the direction of a tool that can be provided at one end 26 of the electric hand-held power tool appliance 10, a damping element 28, which, together with the helical spring 24, constitutes a spring and damping element, succeeds the helical compression spring 24. The damping element 28 is an annular, rubber-elastic elastomer element made of a cellular elastomer or of rubber, which is displaceable in a sliding manner in the housing part 16 and held here between two shells of the two-shell housing part 16. Through the displacement of the elastomer damping element 28, its damping effect can be set in a variable manner.

The guide bolt 4 in this case is arranged in the central bore of the damping element 28, the guide bolt 4 being surrounded by a slide sleeve 5, which constitutes the actual seat for the damping element 28. In this case, a bias can be applied to the helical compression spring 24 via the slide sleeve 5 without the damping element 28 being thereby affected. This mechanism can be seen, in particular, in FIG. 2, a plate 6 being able to be moved, via the slide sleeve 5, in the direction of the helical spring 24, and there being provided, for the purpose of setting the slide sleeve, a screw element 7 that is movable in the axial direction and via which a bias can be applied, via the slide sleeve 5, to the plate 6 and to the coils of the helical spring 24.

Through the selection of the spring stiffnesses, both of the helical compression spring 24 and of the damping element 28, the stiffness of the spring and damping element can be so set that the stiffness in the axial direction 12 is less than in a floating direction, floating direction being understood to be the directions perpendicular to the axial direction 12. In this way, a spongy feel during working can be prevented, and good vibration damping can nevertheless be achieved in the main direction of loading, namely, in the axial direction.

In this way, the vibration reduction at the handle 18 is achieved, in particular in the main axial direction 12.

In this case, it is exclusively the damping element 28 that acts in the directions perpendicular to the main axial direction 12, whereas both the spring element 24 and the damping element 28 act in the axial direction, and thereby enable a greater softness to be set.

In this case, provision can be made, at the second joining point 20, whereby there is provided here only one damping element 30, which reduces the damping in all three directions in space. In this way, a greater stiffness is provided in this region.

An electric hand-held power tool providing a good damping characteristic can be provided particularly easily in the manner described above.

1. Electric hand-held power tool appliance, comprising a first housing part, in particular for accommodating a transmission and/or a drive motor for a tool, and comprising a second housing part, for constituting a handle for guiding the electric hand-held power tool appliance, the first and the second housing part being connectable to one another, and being able to be vibrationally decoupled from one another, at least partially, in that at least one spring and damping element is arranged between the housing parts at least one joining point, characterized in that there is provided, as a spring and damping element, a helical compression spring having at least one rubber or rubber-elastic damping element succeeding in an axial direction as viewed from a tool side.

2. Electric hand-held power tool appliance according to claim 1, characterized in that at least one damping element is composed of cellular elastomer.

3. Electric hand-held power tool appliance according to claim 2, characterized in that the helical compression spring has a spring stiffness that differs from that of the at least one rubber-elastic or rubber damping element.

4. Electric hand-held power tool appliance according to claim 3, characterized in that the second housing part is fixed to the first housing part via two joining points, only one rubber-elastic or rubber damping element being provided, in particular, at the second joining point.

5. Electric hand-held power tool appliance according to claim 4, characterized in that the at least one damping element is realized as an annular element.

6. Electric hand-held power tool appliance according to claim 5, characterized in that the bias of the helical compression spring is settable, in particular steplessly.

7. Electric hand-held power tool appliance according to claim 6, characterized in that the damping element in the second housing part is held between two housing shells of the same.

8. Electric hand-held power tool appliance according to claim 7, characterized in that the damping element in the second housing part is axially displaceable.

9. Electric hand-held power tool appliance according to claim 8, characterized in that it is, in particular, a hammer drill or a percussion drill.
